(19) United States
(12) Patent Application Publication
(10) Pub. No.: US 2010/0063622 A1
(43) Pub. Date: Mar. 11, 2010

(54) AUTOMATED COMPLIANCE WITH DO-NOT-MAIL REQUIREMENTS

(75) Inventor: Michael D. Fappiano, Waterbury, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/207,919

(22) Filed: Sep. 10, 2008

(51) Int. Cl. B07C 5/00

(52) U.S. Cl. 700/224

(57) ABSTRACT

A method includes feeding a mailpiece into a sorter and transporting the mailpiece through the sorter. The method further includes reading addressing information from the mailpiece in the sorter, and comparing the addressing information with at least one do-not-mail list. In addition, the method includes outsorting the mailpiece from the mailstream if the addressing information indicates a recipient who is listed in the do-not-mail list.

### FIELD OF THE INVENTION

The invention disclosed herein relates generally to processing of large quantities of mail.

### BACKGROUND

Some mail recipients prefer not to receive unsolicited mailpieces that contain commercial offers, advertisements, and the like. Opposition to such unsolicited mailpieces has become visible and may at some point result in enactment of laws or regulations that implement a “do not mail” requirement. Such laws or regulations would permit individuals who object to receiving unsolicited mailpieces to place their names on a do not mail (DNM) list, and would impose penalties on mailers who send unsolicited mail to mail recipients who are on the list.

If such laws or regulations come into effect, mailers may face certain practical difficulties in achieving compliance. For example, if a mailer's mailing list has not been updated to reflect the latest composition of a do not mail list, then the mailer may inadvertently violate the do not mail law or regulation. This problem may be particularly difficult to address for mailers who buy or rent mailing lists from third parties. In those situations, the mailer may not be assured that the source of the mailing list has kept it up to date in terms of reflecting current do not mail lists. Again, the mailer may face the risk of inadvertently violating do not mail requirements.

U.S. Pat. Nos. 5,422,821; 5,703,783; 6,292,709; and 6,741,724 are generally concerned with change of address and/or mail forwarding processes, and do not address issues that may potentially be raised by do not mail requirements.

### SUMMARY

According to an aspect of the invention, a method includes feeding a mailpiece into a sorter. The method further includes transporting the mailpiece through the sorter, and reading addressing information from the mailpiece in the sorter. The method also includes comparing the addressing information with at least one do-not-mail list, and outsorting the mailpiece from the mailstream if the addressing information indicates a recipient who is listed in the do not mail list.

The mailpiece may be a direct mailpiece. As is familiar to those who are skilled in the art, a direct mailpiece is one which contains an advertisement or marketing communication that was not solicited by the recipient. The method may further include receiving the mailpiece from the sender (i.e., a third party that generated the mailpiece) prior to the feeding step. The do-not-mail list, too, may be received from a third party before the mailpiece is compared with the do-not-mail list. The addressing information may indicate a correct address for the recipient. The feeding, transporting, reading, comparing and outsorting steps may be performed in a pre-sort house. The reading step may include reading a barcode and/or using optical character recognition to read alphanumeric characters.

The method may further include providing feedback to the mailer by transmitting an image of the outsorted mailpiece, or an indication that the mailpiece has been outsorted, or sending the mailpiece itself, back to the entity that generated the mailpiece.

In another aspect, a method includes receiving a mailpiece and determining whether the mailpiece is in a class of mailpieces subject to a do-not mail rule. If the mailpiece is in that class, the method also includes reading addressing information from the mailpiece, comparing the addressing information with at least one do-not-mail list, and outsorting the mailpiece from the mailstream if the addressing information indicates that the recipient is listed in the do-not-mail list.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic diagram of an automatic mailpiece sorting machine (sorter) provided according to some aspects of the invention.

FIG. 2 is a block diagram of a control component that is part of the sorter of FIG. 1.

FIG. 3 is a flow chart that illustrates a process that may be performed in the sorter of FIG. 1 in accordance with aspects of the present invention.

### DETAILED DESCRIPTION

The present invention adapts a sorter (automatic mailpiece sorting machine) to assure compliance with do not mail requirements as part of the same operation in which mailpieces are sorted for the purpose of obtaining postal pre-sort discounts or for similar purposes. The adaptation of the sorter may include interfacing the controller for the sorter to a do-not-mail list database, checking the addresses/addressees indicated on the mailpieces with the do-not-mail information and outsorting mailpieces that would be forbidden under do not mail rules from being delivered to the addressees.

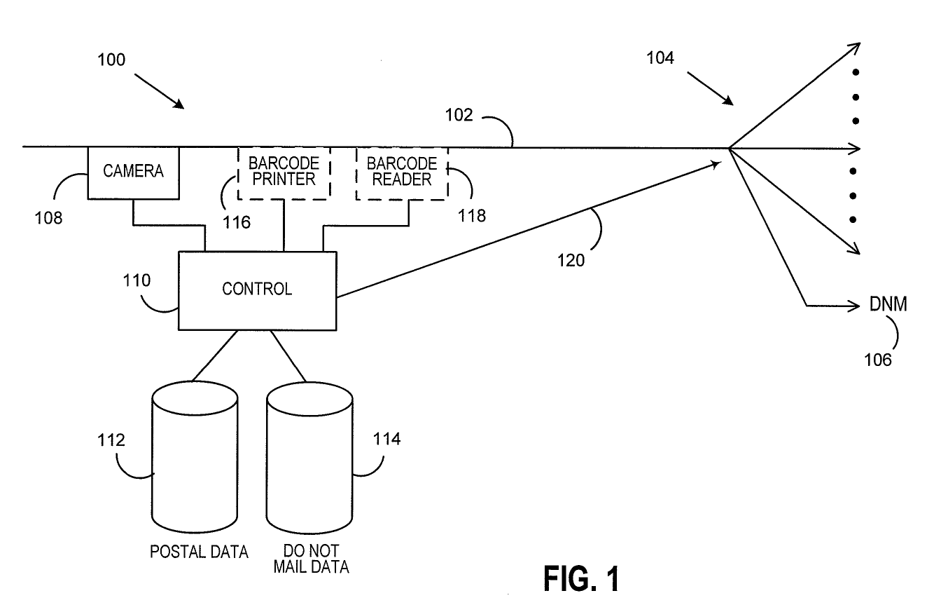

FIG. 1 is a schematic diagram that illustrates a sorter 100 provided in accordance with aspects of the present invention.

In its hardware aspects, the sorter 100 may be primarily or entirely conventional. For example, the sorter 100 may include a conventional mailpiece transport, indicated schematically at 102, which transports mailpieces (not shown) seriatim to a sorter section that is schematically indicated at 104. Via conventional mechanical arrangements, the sorter section 104 sorts the mail pieces into a number of different bins, which in general are not explicitly shown. However, the drawing does schematically indicate a do not mail (DNM) bin 106, into which certain mailpieces may be outsorted, in accordance with aspects of the present invention, for the purpose of do not mail compliance. As a practical matter, any bin of the sorter 100 may be selected to be the DNM bin, as may be convenient for operational purposes.

The sorter 100 may also include a camera 108 positioned adjacent to the mailpiece transport 102 in such a manner as to allow the camera 108 to capture images of addressing information printed on the mailpieces. In particular, the camera 108 may capture some or all of the recipient address, including for example the recipient's name.

The sorter 100 further includes, or has associated therewith, a control component 110. The control component 110 is coupled to the camera 108 and may read the addressing information (e.g., by optical character recognition (“OCR”)) captured by the camera 108. The control component 110 may perform other functions described below, including for example control of the sorter section 104 for the purpose of routing mailpieces into the appropriate bins. Details of the control component 110 will be described below. As will be seen, the control component 110 includes, or has associated therewith, a database 112 of standard postal addresses (e.g., a current database of all mail recipient addresses in the U.S.) and a database 114 that includes one or more do not mail lists. As noted above, the do not mail list(s) may have been received from a third party, such as a regulatory body or an industry organization.

In some embodiments, all sortation performed by the sorter 100 is based directly on OCR via the camera 108. However, in other embodiments, at least some sortation is based on barcodes. The sorter 100 thus may include a barcode printer 116 and/or a barcode reader 118 positioned adjacent the mailpiece transport 102. The barcode printer 116 may print destination zip code barcodes on mailpieces based on identification of the recipient's address on the mailpieces via OCR. The barcode reader may read a destination zip code barcode printed on the mailpieces by the barcode printer 116 or pre-printed on the mailpieces. The barcodes printed by the barcode printer 116 and/or read by the barcode reader 118 may, for example, be of the type known as “POSTNET”™ or the “Intelligent Mail”® 4-state barcode that is scheduled for adoption in the near future.

In some embodiments, the sorter 100 is located in and operated by a pre-sort house (which is not shown apart from the sorter 100). As is familiar to those who are skilled in the art, a pre-sort house is a facility that serves its customers by pre-sorting mailings generated by the customers (often by commingling mailings from more than one customer) to obtain postage discounts available for pre-sorted mail.

The sorter 100 may alternatively be operated directly by the mailer.

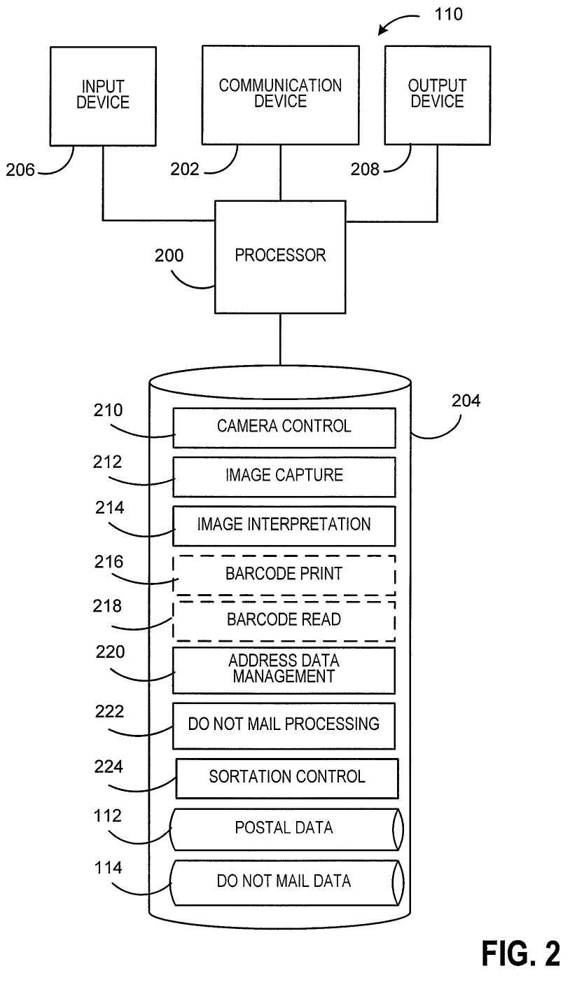

FIG. 2 is a block diagram of an example embodiment of the control component 110. In some embodiments, the control component 110 may be constituted with conventional personal computer hardware, but programmed and loaded with data so as to operate in accordance with aspects of the present invention.

As depicted, the control component 110 includes a computer processor 200 operatively coupled to a communication device 202, a storage device 204, one or more input devices 206 and one or more output devices 208.

Communication device 202 may be used to facilitate communication with, for example, other devices (such as computers operated by entities that generated the mailings fed through the sorter 100). The input device(s) 206 may comprise, for example, a keyboard, a keypad, a mouse or other pointing device, a microphone, knob or a switch, an infra-red (IR) port, a docking station, and/or a touch screen. The camera 108 and/or the barcode reader 118 shown in FIG. 1 may also be considered input devices for the control component 110. Other input devices may include various sensors (not shown) which provide signals to the control component 110 concerning operation of the mailpiece transport 102 and/or the sorter section 104.

The output device(s) 208 may comprise, for example, a display (e.g., a display screen), a speaker, and/or a printer. (The barcode printer 116, if present, may be considered to be an output device for the control component 110. Further, control signals—schematically indicated at 120 in FIG. 1—for controlling the mailpiece transport 102 and/or the sorter section 104 may also be considered outputs from the control component 110.)

Continuing to refer to FIG. 2, storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. At least some of these devices may be considered computer-readable storage media, or may include such media.

Storage device 204 stores one or more programs or program modules (at least some of which being indicated by blocks 210-224) for controlling processor 200. Processor 200 performs instructions of the programs, and thereby operates in accordance with the present invention. In some embodiments, the programs may include a program or program module 210 that controls the camera 108 to capture images of the mailpieces, or at least the recipient address portion of the mailpieces. Program/program module 210 may be provided in accordance with conventional principles.

The programs stored in the storage device 204 may also include a program/program module 212 for controlling the control component 110 to receive and store (in the storage device 204) mailpiece image data captured by the camera 108. Also the storage device 204 may store a program/program module 214 for interpreting the stored mailpiece image data. For example, program/program module 214 may perform optical character recognition to read recipient addressing information captured in the mailpiece image data. The program/program modules 212 and 214 may be provided in accordance with conventional principles.

If the barcode printer 116 and/or the barcode reader 118 are present, then the storage device 204 may store a conventional barcode printer driver 216 and/or a conventional barcode reader driver 218.

The storage device 204 may also store a program/program module 220 which operates to verify the recipient address as captured and read via program/program modules 210-214. In particular, the program/program module 220 may compare the recipient address as read from the mailpiece with the postal information database 112 to determine an address in standard format that matches the recipient address as read from the mailpiece. The program/program module 220 may cooperate with the barcode printer driver 216 to print a destination zip code barcode on the mailpiece that corresponds to the recipient's standard address as found in the postal information database 112. The program/program module 220 may be provided in accordance with conventional principles.

Further, and in accordance with aspects of the present invention, the storage device 204 may store a program/program module 222 that is operative to cause the sorter 100 to outsort mailpieces that do not comply with do not mail requirements. Details of operation of the program/program module 222 will be discussed below.

Still further, the storage device 204 may store a program/program module 224 that controls operation of the mailpiece transport 102 and the sorter section 104 to transport mailpieces and to route them into appropriate ones of the above-mentioned bins. The program/program module 224 may respond to signals from the program/program module 222 so as to outsort to DNM bin 106 (FIG. 1) mailpieces that do not comply with do not mail requirements. Otherwise, the program/program module 224 may be provided substantially in accordance with conventional principles.

FIG. 2 also shows the above-mentioned postal information database 112 and the do not mail list database 114 as being stored on the storage device 204.

There may also be stored in the storage device 204 other software, such as one or more conventional operating systems, device drivers, communications software, etc.

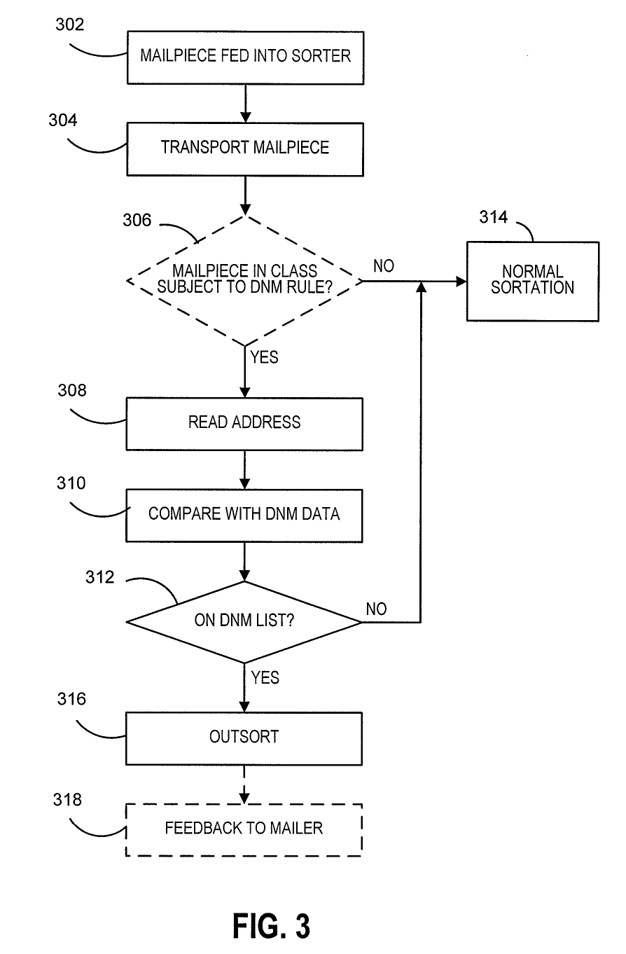

FIG. 3 is flow chart that illustrates a process that may be performed in the sorter 100 in accordance with aspects of the present invention.

At 302 in FIG. 3, a mailpiece is fed into the sorter 100. Typically, this is done as part of feeding an entire mailing of numerous mailpieces into the sorter 100. In fact, as suggested above, several mailings from different mailers may be fed into the sorter 100 one after the other in order to increase sorting densities and thus also to increase the opportunities for postal discounts. It will be appreciated that the mailpiece and the mailing of which it is a part may have been received from a sender such as a mailer that retained the operator of the sorter for pre-sort services, do not mail compliance, etc. The mailpiece, as noted above, may be a direct mailpiece.

At 304, the mailpiece is transported along the mailpiece transport 102.

In some embodiments, the control component 110 may determine, at decision block 306, whether the mailpiece is in a class of mailpieces that is potentially subject to a do not mail requirement. To explain, some do not mail requirements may be effective with respect to some but not all mail addressed to a given recipient. In one example, first class mail may not be subject to do not mail requirements (the recipient still needs to receive his/her utility bills, credit card statements, etc.) but other classes of mail, such as standard mail, may be subject to do not mail requirements.

In other possible do not mail programs, the “class” of mail for present purposes may related to the identity of the mailer. That is, do not mail laws/regulations may allow entities having a pre-established business relationship to send mailpieces to a recipient who is on a do not mail list, but may prohibit all other entities from sending mailpieces to the recipient.

Thus, for example, the determination at 304 may comprise determining what postal class of mail the mailpiece belongs to. Alternatively, the determination at 304 may comprise determining whether the mailer has indicated that it has a pre-established business relationship with all of the recipients of the mailpieces in the mailing. In either or both cases, this determination may be based on information that is input into the control component 110 at the time the mailing is being fed into the sorter 100. In addition or alternatively, the determination as to whether the mailpiece belongs to a class of mailpieces potentially subject to do not mail requirements may be based on reading either or both of the (mailer's) return address or a class of mail imprint on the mailpiece, and/or by detecting the size or dimensions of the mailpiece.

The above are only examples of classes or types of mailpieces that may or may not be subject to do not mail requirements.

The determination at 306 may be made before and/or during either or both of steps 302 and 304.

If a positive determination is made at 306 (i.e., if it is determined that the mailpiece belongs to a class of mailpieces that is potentially subject to do not mail requirements), then the process of FIG. 3 may advance to 308 and 310. At 308, the control component 110, in conjunction with the camera 108 and/or the barcode reader 118, reads the recipient's address (or information, such as a barcode that represents an 11l-digit zip code, that is indicative of the recipient's address) from the mailpiece. This may entail either or both of optical character recognition and barcode reading. In some embodiments, this step may also entail cross-checking the recipient's address as read from the mailpiece against the standard postal addresses in the postal information database 112 to arrive at the standard format for the recipient's address. Next, at 310, the recipient's address in the standard format is used to check one or more do not mail lists contained in the do not mail database 114. That is, the recipient's address is compared with the do not mail list(s) in the database 114 to determine whether the indicated recipient is listed in the do not mail list.

Decision block 312 represents a determination as to whether the recipient indicated on the mailpiece is listed in the do not mail list(s). If such is not the case, then the sorter 100 (under the control of the control component 110) sorts the mailpiece in a conventional manner, as indicated by block 314. However, if a positive determination is made at 312 (i.e., if the control component 110 determines that the indicated recipient is listed in a do not mail list), then the process of FIG. 3 advances to block 316. At block 316, the control component 110 controls the sorter 100 to outsort the mailpiece from the mailstream by routing the mailpiece to the DNM bin 106 (FIG. 1). It should be understood that “outsorting a mailpiece from the mailstream” refers to sorting the mailpiece into a sorting bin such that the mailpiece is diverted from being delivered to the recipient indicated on the mailpiece.

In some embodiments, the process may also include providing feedback to the mailer (block 318) to indicate that the mailpiece was outsorted to comply with a do not mail requirement. For example, the mailpiece itself may simply be sent back to the mailer (possibly with a notation thereon to indicate that a do not mail requirement prevents its delivery to the recipient). Alternatively, the control component 110 may send a message or data file to the mailer. The message or data file may include the recipient's name and/or address (or a proxy therefor, such as an 11-digit zip code) so that the mailer can cleanse its mailing list. The control component 110 may send the message or data file via a data network (not shown) to a computer (not shown) that is operated for or on behalf of the mailer. It should be understood that “mailer” refers to the entity that generated the mailpiece.

As still another alternative, the control component 110 may send to the mailer an image of the mailpiece or of a portion of the mailpiece that includes the recipient's address.

Considering again decision block 306, if a negative determination is made at that point (i.e., if it is determined that the mailpiece does not belong to a class of mailpieces that is potentially subject to a DNM requirement), then the sorter 100 sorts the mailpiece in a conventional manner, as indicated by block 314.

Operation of the sorter to outsort mailpieces forbidden from delivery to the recipient by DNM rules may provide a “last line of defense” to save the mailer/pre-sort house from violating a DNM requirement. Moreover, DNM screening may also be a revenue-generator for the pre-sort house. For example, the pre-sort house may charge the mailer a modest per-piece fee for DNM screening, or a flat fee per mailing, or a considerably larger fee for each outsorted mailpiece that would have violated a DNM requirement.

As used herein and in the appended claims, the term “do not mail rule” refers to a law or regulation that forbids or restricts mailing of mailpieces to recipients listed on a do not mail list.

As used herein and in the appended claims, the term “do not mail list” refers to a list of mail recipients who have indicated that they do not wish to receive at least one type of mailpiece addressed to the recipient's current mailing address.

As used herein and in the appended claims, the term “addressing information” refers to text and/or barcode information that is indicative of a mailing address.

The flow chart and/or process description contained herein should not be assumed to imply a fixed order for performing process steps. Rather, process steps may be performed in any order that is practicable.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
feeding a mailpiece into a sorter;
transporting the mailpiece through the sorter;
reading addressing information from the mailpiece in the sorter;
comparing the addressing information with at least one do-not-mail list; and
outsorting the mailpiece from a mailstream if the addressing information indicates a recipient who is listed in the do-not-mail list.

2. The method of claim 1, wherein the mailpiece is a direct mailpiece.

3. The method of claim 1, further comprising:
receiving the mailpiece from a sender prior to said feeding step.

4. The method of claim 1, further comprising:
receiving the do-not-mail list from a third party prior to the comparing step.

5. The method of claim 1, wherein the addressing information is indicative of a correct address for the recipient.

6. The method of claim 1, wherein said feeding, transporting, reading, comparing and outsorting are performed at a pre-sort house.

7. The method of claim 1, wherein said reading step includes reading a barcode.

8. The method of claim 1, wherein said reading step includes using optical character recognition to read alphanumeric characters.

9. The method of claim 1, further comprising:
printing a barcode on the mailpiece.

10. The method of claim 1, further comprising:
transmitting an image of said outsorted mailpiece to an entity that generated the mailpiece.

11. The method of claim 1, further comprising:
sending the outsorted mailpiece back to an entity that generated the mailpiece.

12. The method of claim 1, further comprising:
transmitting, to an entity that generated the mailpiece, an indication that the mailpiece has been outsorted.

13. A method comprising:
receiving a mailpiece;
determining whether the mailpiece is in a class of mailpieces subject to a do-not-mail rule; and
if said mailpiece is in said class:
reading addressing information from said mailpiece;
comparing the addressing information with at least one do-not-mail list; and
outsorting the mailpiece from a mailstream if the addressing information indicates a recipient who is listed in the do-not-mail list.

14. The method of claim 13, wherein said reading, comparing and outsorting are performed at a pre-sort house.

15. The method of claim 13, wherein said reading step includes reading a barcode.

16. The method of claim 13, wherein said reading step includes using optical character recognition to read alphanumeric characters.

17. The method of claim 13, further comprising:
transmitting an image of said outsorted mailpiece to an entity that generated the mailpiece.

18. The method of claim 13, further comprising:
sending the outsorted mailpiece back to an entity that generated the mailpiece.

19. The method of claim 13, further comprising:
transmitting, to an entity that generated the mailpiece, an indication that the mailpiece has been outsorted.
